(19) United States
(12) Patent Application Publication
(10) Pub. No.: US 2016/0184618 A9
(43) Pub. Date: Jun. 30, 2016

(54) Extraction System and Method

(71) Applicant: Adaptive Rescue Concepts, LLC, Plainfield, IL (US)

(72) Inventors: Bruce Michael Bina, Plainfield, IL (US); Christopher John Echols, Palatine, IL (US); Kenneth Chester Wojcik, Naperville, IL (US); Richard Kenneth Banske, Calumet City, IL (US); Kenneth John Lee, Highland, IN (US); Robert J. Grozewski, Munster, IN (US); Peter Gisslen, Lake Barrington, IL (US)

(21) Appl. No.: 14/231,237

(22) Filed: Mar. 31, 2014

Related U.S. Application Data
(60) Provisional application No. 61/806,822, filed on Mar. 30, 2013.

(51) Int. Cl. A62B 99/00; A62B 35/00; B66B 9/193; B66B 9/187

(52) U.S. Cl. CPC A62B 99/00; B66B 9/187; A62B 35/0018; B66B 9/193

(57) ABSTRACT

An extraction system and method. The system has a hoist assembly and a sled. The hoist assembly has two spaced apart rail connecting members configured to connect with rails of an end of a ladder. The hoist assembly also has a winch. The winch has a cable. The sled has frame, a platform connected to the frame, and a harness connecting a rider to the platform. The cable is releasably connected to the sled. The winch is operable to move the sled via the cable along the ladder from a lowered position to a raised position.

This application claims the benefit of U.S. Patent Application No. 61/806,822, filed on Mar. 30, 2013, which is incorporated herein by reference in its entirety.

### FIELD OF THE INVENTION

This invention relates in general to systems and methods for extracting persons.

### BACKGROUND OF THE INVENTION

Conventional emergency extraction methods and systems used by many emergency workers, such as firefighters, presently involve using a rope method to rescue the victim. Extraction generally involves lifting a victim from a lower location to a higher location with multiple ropes. In many cases, the rope rescue technique requires at least four firefighters to pull on the rescue victim at the same time via four ropes. The firefighters have to synchronize their rope lifting effort so as not to further injure the victim and to make sure the victim is stable throughout the entire rescue process. Two firefighters are needed to attach the ropes to the rescue victim. Two or three more firefighters are needed to remove the rescue victim from the ropes. The complete rescue process often takes several minutes to complete and cases this could take as much as ten minutes on average.

The traditional rope method may induce additional stress on the human body and in some cases this stress may injure the firefighter who is involved in the rescue operation. There is research data that suggests that at least six percent of injured firefighters receive their injuries during an extraction process each year. It could take the injured firefighter several months to recover before returning back to duty.

The present inventors recognized the need for a more efficient method of rescuing a victim than is currently provided by the rope method. The present inventors recognized the need for a system and method that reduces the overall time required to complete an extraction and reduces the number of rescue team members required to perform the rescue operation. The present inventors recognized the need for a system and method for extraction that reduces the likelihood of further injury of the victim during the extraction. The present inventors recognized a need for a system that will reduce the physical strain on the rescuer.

### SUMMARY OF THE INVENTION

An extraction system having a hoist assembly and a sled is disclosed. The hoist assembly has two spaced apart rail receiving members configured to connect with side rails of one end of a ladder. The hoist assembly also has a winch. The winch has a cable. The sled has a frame, a platform connected to the frame, and a harness connecting a rider to the platform. The cable is releasably connected to the sled. The winch is operable to move the sled via the cable along the ladder from a lowered position to a raised position.

In some embodiments, the sled has rollers configured to roll along the side rails of the ladder when the sled is moved along the ladder by the winch.

In some embodiments, the sled has a plurality of attachments locations for anchoring a plurality of straps of the harness. The harness system has at least one buckle for connecting at least two of the plurality of straps together about a rider. In some embodiments, the harness is a six-point harness system configured to support a rider's chest, torso, and legs.

In some embodiments, the cable is releasably connected to the sled by a quick release mechanism. The sled has a hook receiver and the cable has a closable hook configured to connect with the hook receiver.

In some embodiments, the sled has one or more handles.

In some embodiments, the hoist assembly has a crossbar connecting the rail receiving members. The winch is connected to the crossbar on a side of the cross bar opposite of the rail receiving members.

In some embodiments, the rail receiving members each have a housing enclosed on three sides with a lower opening for receiving the corresponding rail of the ladder.

In some embodiments, the hoist assembly has one or more pulleys to route the cable to a location between the rail receiving members.

In some embodiments, the winch has a hand crank rotatable to move the cable in at least one direction.

In some embodiments, the winch is driven by an electric motor.

In some embodiments, the hoist assembly has one or more lights for illuminating a work area.

In some embodiments, the hoist assembly has one or more lighting control units for controlling the operation of the one or more lights.

In some embodiments, the lights are light emitting diodes. In some embodiments, the one or more lighting control units have a lighting color selector for selecting the color of light to be illuminated from the one or more light emitting diodes.

A method of extracting a person from a lower level is disclosed. A ladder is positioned on the lower level. The ladder extends from the lower level to an upper level. Two spaced apart rail connectors of a hoist assembly are attached to the upper end of the side rails of the ladder. The person located at the lower level is secured to a sled with a harness. The sled is drawn up the ladder toward the upper level with a winch of the hoist assembly. The winch is connected to the sled by a cable.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a perspective view of an extraction system of the invention deployed on a ladder between two levels.

FIG. 2 is a perspective view of the extraction system of FIG. 1 with a sled of the extraction system having a rider in a lowered position, the sled and rider shown transparently.

FIG. 3 is a perspective view of the extraction system of FIG. 1 with a sled of the extraction system having a rider in a raised position, the sled and rider shown transparently.

FIG. 4 is a front view of a first embodiment sled of the extraction system of FIG. 1.

FIG. 5 is a front view of the sled of FIG. 4.

FIG. 6 is an end view of the sled of FIG. 4.

FIG. 7 is a side view of a lower portion of the sled of FIG. 4.

FIG. 8 is a front view of a second embodiment sled of the extraction system of FIG. 1.

FIG. 9 is a side view of a handle and side bar of the sled of FIG. 8.

FIG. 10 is a front view of a rider connected to the sled of FIG. 4 with a harness system.

FIG. 11 is a side view of a rider connected to the sled of FIG. 10.

FIG. 12 is a side view of a rider connected to the sled of FIG. 10.

FIG. 13 is a front view of a hoist assembly of the extraction system of FIG. 1.

FIG. 14 is a rear view of the hoist assembly of FIG. 13.

FIG. 15 is a left side view of the hoist assembly of FIG. 13.

FIG. 16 is a right side view of the hoist assembly of FIG. 13.

FIG. 17 is a bottom view of a lighting unit of the hoist assembly of FIG. 13.

FIG. 18 is a rear view of a portion of a winch unit of the hoist assembly of FIG. 13.

FIG. 19 is a front view of an alternative embodiment hoist assembly with the winch unit rotated ninety degrees.

FIG. 20 is a side view of a L-bracket from FIG. 19.

### DETAILED DESCRIPTION

An extraction system and method are disclosed. The following description is presented to enable any person skilled in the art to make and use the invention. For the purposes of explanation, specific nomenclature is set forth to provide a plural understanding of the present invention. While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

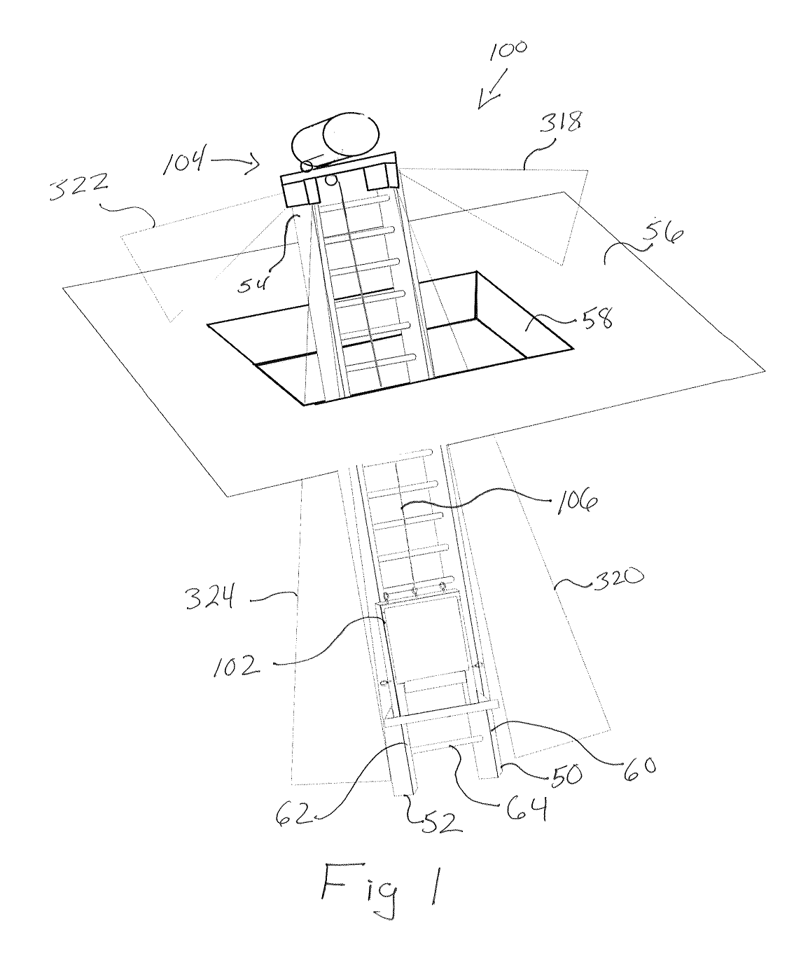

FIGS. 1-3 show an extraction system 100 of the invention. The extraction system comprises a hoist assembly 104 and a sled 102. The hoist assembly is connectable to the sled 102 by a cable 106. The extraction system is usable with a conventional ladder 50. The ladder has two spaced apart side rails 60, 62 connected by a plurality of rungs 64. The extraction system can be used on any type of ladder. In one embodiment, the ladder is between 8 and 20 feet long and has a ladder rail depth in the range of 18 to 20 inches.

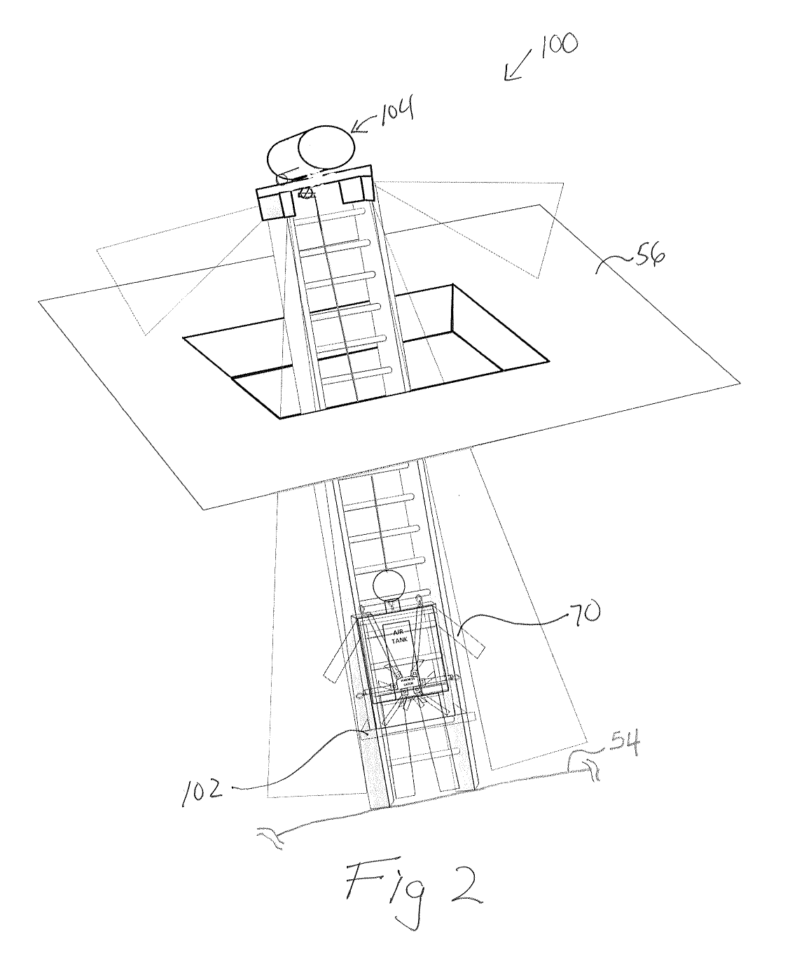

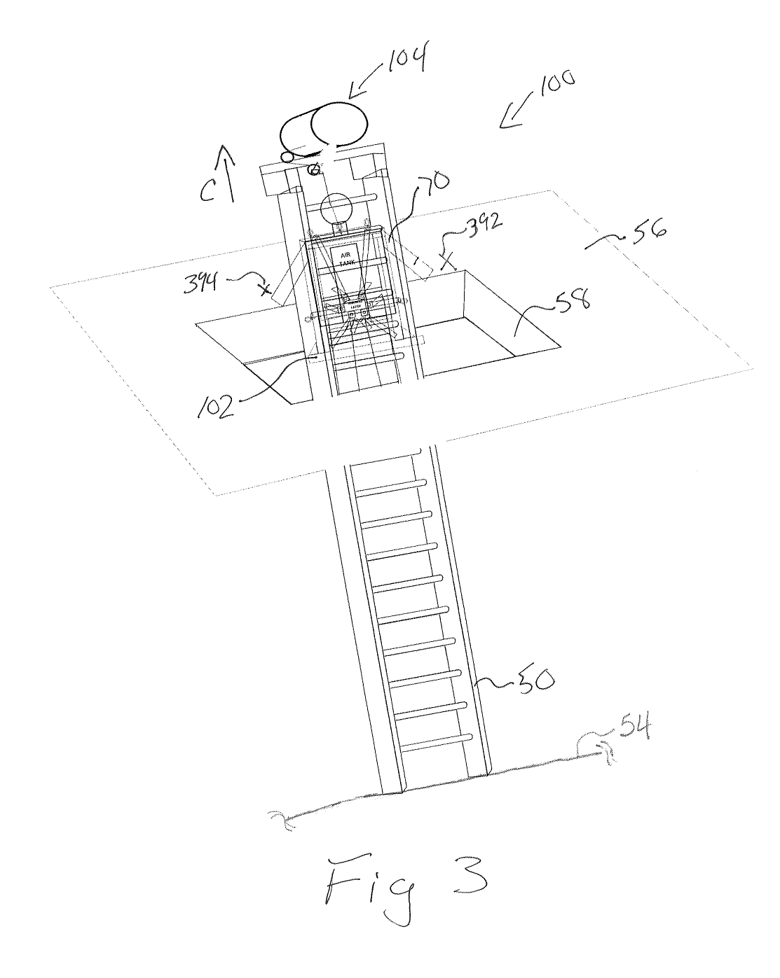

The lift assembly can move the sled 102, having a person 70, from a bottom area 52 of the ladder, as shown in FIGS. 1 and 2, to a top area of the ladder 50 along the rails 60, 62, as shown in FIG. 3. This can facilitate the extraction of a person from a lower level/floor 54 to an upper level/floor 56 or area. FIG. 1 shows the upper floor 56 has a rectangular opening 58 through which the ladder 50 extends. The ladder rests against an edge of the opening 58 and on the lower/level floor 54. However, it will be recognized that the extraction system can be used through any opening or any situation where lifting is required or desired from a lower area to a higher area.

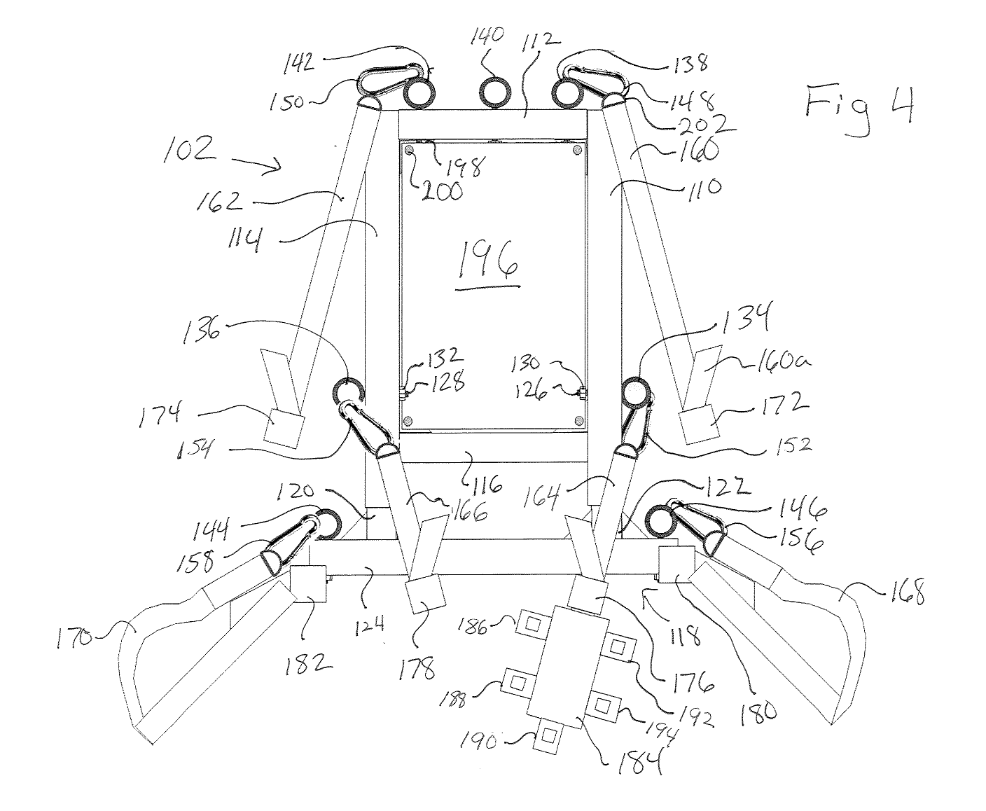

FIGS. 4 and 5 show a first embodiment of the sled 102. The sled has a frame comprising a right bar 110, a top bar 112, a left bar 114 a bottom bar 116, and a lower portion 118. The lower portion has a crossbar 124. A right connecting bar 122 and a left connecting bar 120 extend from the crossbar 124. The right connecting bar 122 is received in a lower opening of the right bar 110 and secured thereto by a right transverse eye bolt 126 and a nut 130. The left connecting bar 120 is received in a lower opening of the left bar 114 and secured thereto by a right transverse eye bolt 128 and a nut 132.

The sled comprises a right upper eyelet 138, a center upper eyelet 140, a left upper eyelet 142, a right mid eyelet 134, a left mid eyelet 136, a right lower eyelet 146, and a left lower eyelet 144. Each eyelet may correspond to an eye bolt connected to the corresponding portion of the sled frame. Connectors, such as releasable D-ring connectors 148, 150, 152, 154, 156, 158, are used to connect the harness belt components of a harness belt system to the sled frame at belt end loops, such as loop 202. The connections between the eyelets and the D-ring connectors, and the D-ring connectors and the belt end loops are diagrammatically shown in FIGS. 4 and 5.

In one embodiment, the D-rings have a main body 154a, a hook portion 154b, a closing bar 154c. The closing bar is pivotally attached to the main body at a pivot joint 154d at a lower end of the closing bar. The pivot joint has a spring that biases the closing bar in the direction D. The pivot bar contacts the end 154e of the hook portion at an end of the pivot bar opposite the pivot joint and prevents the pivot bar from moving further in the direction D. The D-ring can be connected or disconnected to an eyelet or belt loop 202 by pressing the closing bar in the direction E to provide an opening for entry or exit of the eyelet or belt loop 202 into or out of the interior space of the D-Ring.

FIG. 5 shows one type of harness system 161. The harness system comprises an upper right holder strap 160, and upper left shoulder strap 162, a right mid strap 164, a left mid strap 166, a right lower strap 168, and a left lower strap 170. Each of the straps 160, 162, 164, 166, 168, and 170 have a corresponding buckle receiver 172, 174, 176, 178, 180, and 182. The straps are adjustable at the buckle receiver so that the buckle can be moved along the strap, leaving an end portion un-tensioned, such as end portion 160a.

The straps 160, 162, 164, 166, 168, 170 may be color coded so that the user knows the manner in which the straps connect about a rider. For example, the shoulder straps could be one color, the mid straps could be another color, and the lower straps could be another color. The straps can be secured to a rider to restrain a rider's chest, torso, and legs by the corresponding straps.

The buckle receivers are connectable to a joining member 184. The joining member 184 has an upper right shoulder strap buckle protrusion 186, and upper left shoulder buckle protrusion 188, a right mid strap buckle protrusion (not shown), a left mid strap buckle protrusion 190, a right lower strap buckle protrusion 192, and a left lower strap buckle protrusion 194. Each of the buckle receivers has a releasable locking mechanism (not shown) that locks the buckle receiver to the corresponding buckle protrusion at least until the release button is activated. FIG. 5 shows the harness system in the fully connected configuration with each belt attached to the joining member 184. Other human harness restrain systems can be used. In one application, the harness assembly 32 can be connected about a victim in between 15 and 20 seconds.

The sled has a body plate 196 between the bars 110, 112, 114, 116. The body is supported by attachment, with a fastener 200, to triangular corner members 198, at each corner. The triangular corner members are attached to the corresponding adjacent bars 110, 112, 114, 116.

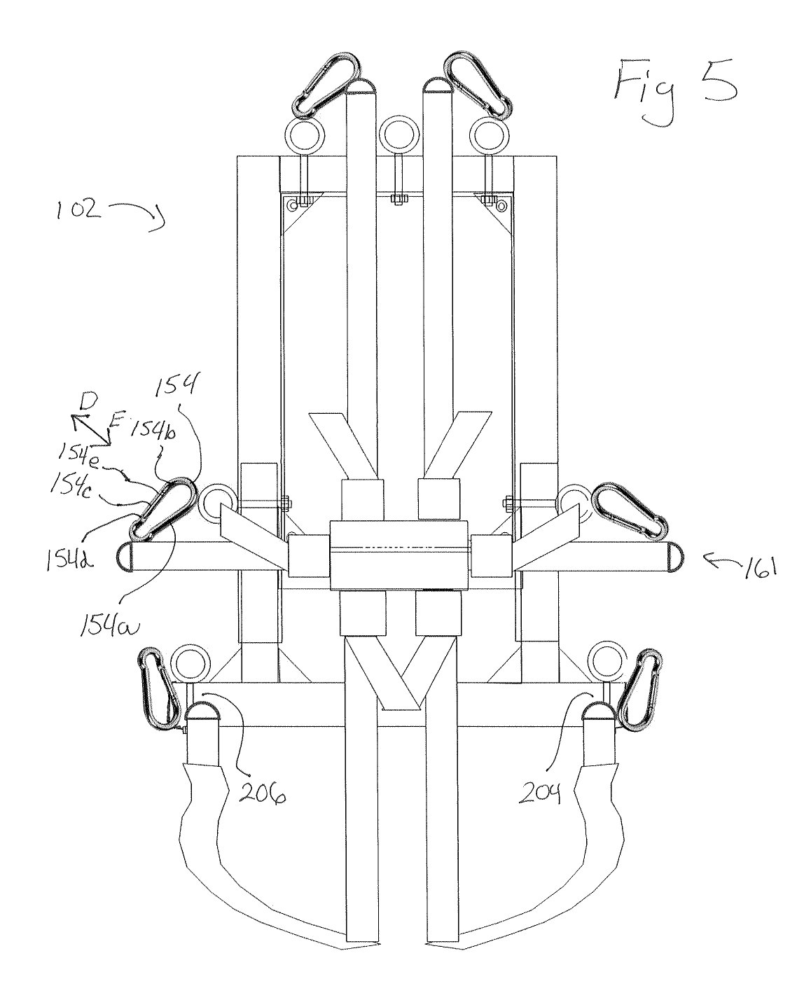

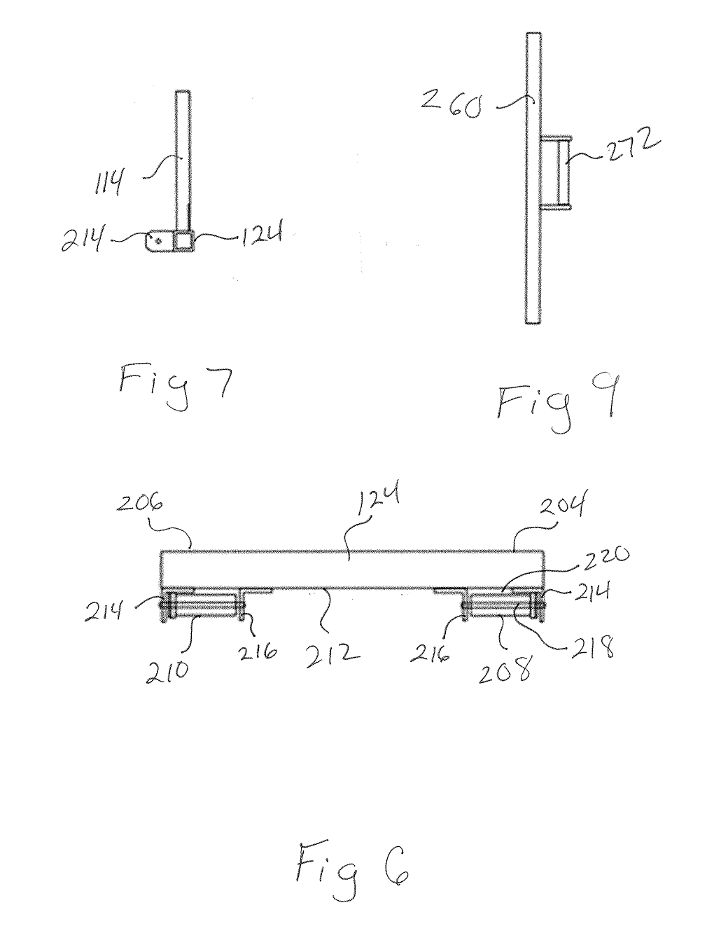

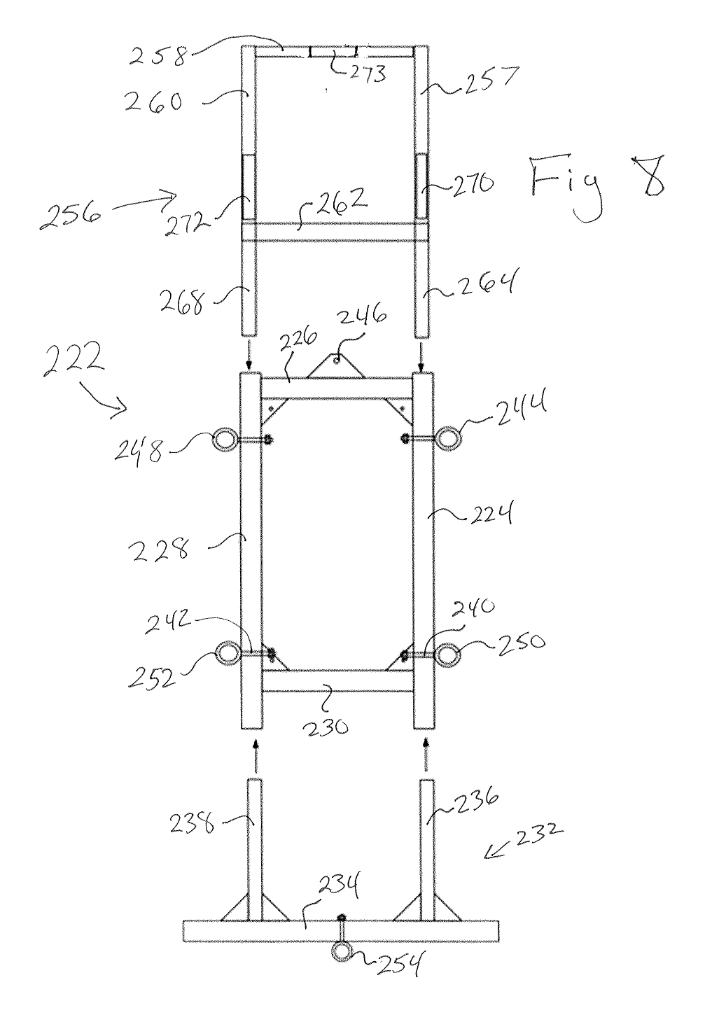

FIG. 6 shows that the sled comprises rollers 208, 210. The right roller 208 is attached a right side portion 204 of the crossbar 124 on a back side 212. The left roller 210 is attached to a left side portion 206 of the crossbar 124 on the back side 212. The right and left side portions 204, 206 extend laterally beyond the location of the right bar 110 and the left bar 114.

Both the right and left rollers 208, 210 are attached in the same manner, therefore only the attachment of the right roller will be described. An axle pin 218 extends through an axle passage (not shown) of the roller. The axle pin 218 is supported on opposite sides by side brackets 214, 216. The axle pin may be fixed to each side bracket and the roller may rotate about the fixed pin. In another embodiment, the pin may be mounted to rotate at the connection with each side bracket. The axle pin is mounted to the brackets so that an upper gap 220 is formed between the roller and the back side 212 of the crossbar 124. Roller 208 is configured to make contact and roll along the upper surface of the right rail 60 of the ladder 50. Roller 210 is configured to make contact and roll along the upper surface of the right rail 62 of the ladder 50.

The rollers 208, 210 reduce the friction between the sled and the ladder. The rollers also keep the sled stable on the ladder rails to prevent the sled from sliding off the ladder.

FIG. 8 shows a second embodiment sled 222. The sled has a frame comprising a right bar 224, a top bar 226, a left bar 228, a bottom bar 230, and a lower portion 232. The lower portion has a crossbar 234. A right connecting bar 236 and a left connecting bar 238 extend from the crossbar 234. The right connecting bar 236 is received in a lower opening (not labeled) of the right bar 224 and secured therein by a right transverse eye bolt 240. The left connecting bar 238 is received in a lower opening of the left bar 228 and secured therein by a right transverse eye bolt 242. The crossbar 234 has the same rollers mounted and operated in the same manner as rollers 208, 210 mounted to the first embodiment sled 102.

The sled comprises a right upper eyelet 244, a center upper eyelet 246, a left upper eyelet 248, a right mid eyelet 250, a left mid eyelet 252, and a lower center eyelet 254. Each eyelet may correspond to an eye bolt connected to the corresponding portion of the sled frame.

The same connectors, such as releasable D-ring connectors 148, 150, 152, 154, 156, 158, that are used with the first embodiment sled can be used with the second embodiment sled. The second embodiment has one less eyelet as compared to the first embodiment sled and therefore one of D-rings 156 or 158 may not be used with the second embodiment. In another embodiment, the second embodiment sled has a right lower eyelet and a left lower eyelet in the same locations as the right lower eyelet 146 and the left lower eyelet 144 of the first embodiment sled.

The right upper eyelet 244 and the left upper eyelet 248 of the second embodiment are located along the sides of the frame rather than the top as with the first embodiment. The D-rings, which are the same or similar to those shown in FIG. 4, are used to connect the harness belt components of a harness belt system to the second embodiment sled frame at belt end loops. In some embodiments, the straps of the harness are connected directly to the eyelets with belt loops without D-rings.

The second embodiment sled can receive an upper extension 256. The upper extension 256 comprises a right bar 257, a top bar 258, a left bar 260, and a cross member 262. The right bar 257 comprises a lower portion 264 extending below the cross member 262. The left bar 257 comprises a lower portion 268 extending below the cross member 262. Each of the lower portions 264, 268 are configured to be received in an upper opening (not labeled) of the corresponding right and left 224, 228 bars and secured therein by a transverse eye bolts and a nuts at the corresponding eyelet 244, 248. The upper extension can be received into the main portion of the frame until the cross-member 262 meets the top edge of the right and left bars 224, 228. Each of the right and left bars 257, 260 of the extension 256 comprise a handle 270, 272 located adjacent to the cross member 262. The top bar 258 may comprises a handle 273. In some embodiments, the handle extends across the entire length of the top bar 258 between the left and right bars 257, 260. The handles 270, 272, 273 provides a convenient place for rescuers to grab and lift the sled as the sled reaches a raised position and for otherwise maneuvering the sled.

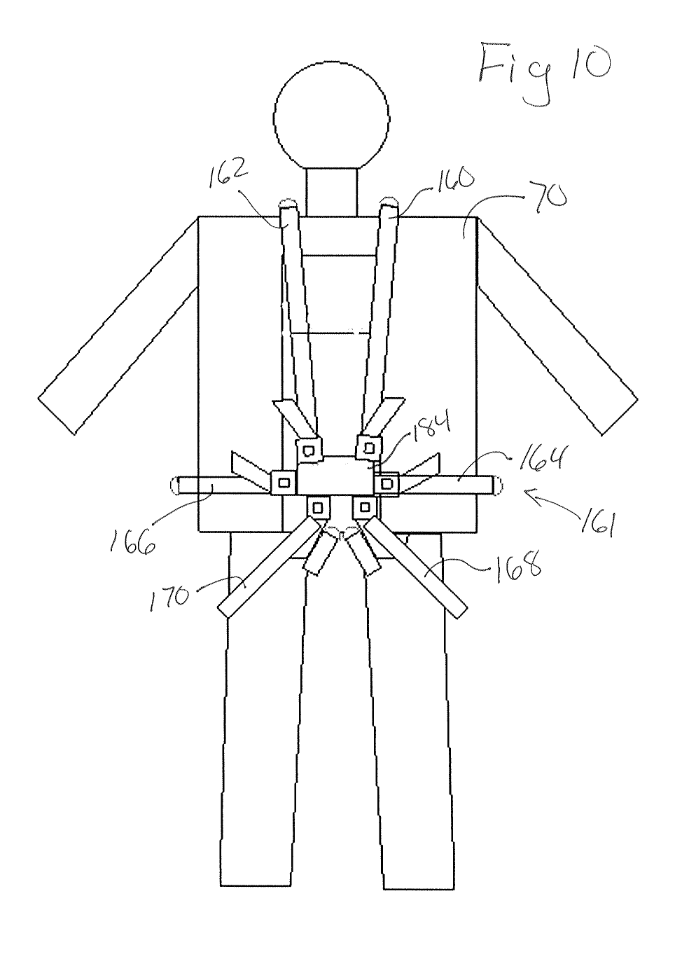

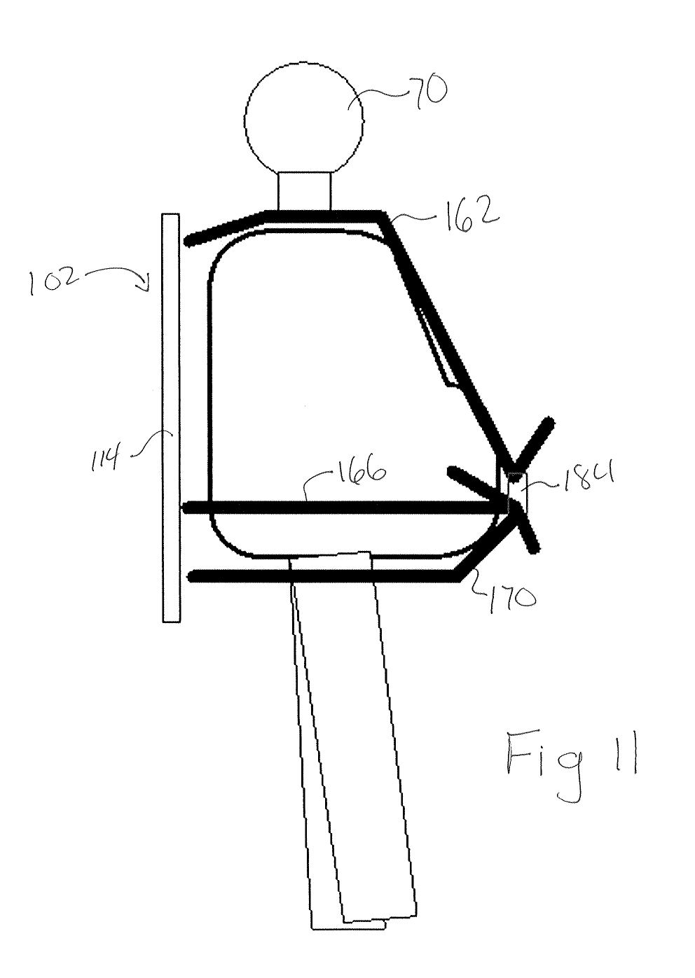

FIGS. 10-12 show a person 70 secured to the sled 102 with the harness system shown in FIG. 4. In some embodiments, the lower eyelets 144, 146 may be paced closer to the center of the cross bar 124, like as provided on the second embodiment sled 222, so that the lower straps 168, 170 can go between the person's legs rather than on the outside of the person's legs. The straps 160, 162 extend over opposite shoulders of the person 70 with the person's head and neck there between. The straps 166, 164 extend about the person's waist.

FIG. 12 shows an air tank 72 strapped to the person's chest within the harness system. This is helpful because if an emergency worker, such as a firefighter, is the person being rescued or extracted, the firefighter's oxygen tank can be extracted together with the firefighter in one step.

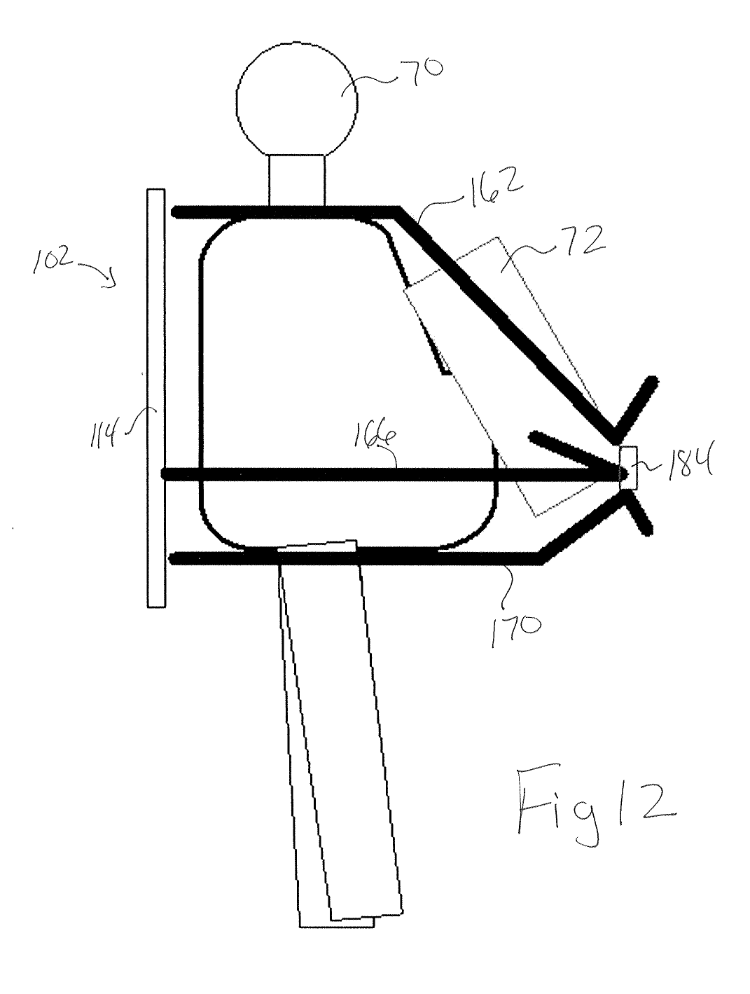

FIGS. 13-16 show the hoist assembly. The hoist assembly comprises a winch unit 280, front and back frame members 282, 283, right and left ladder rail receivers 284, 286, and right and left lighting units 288, 290. The front and back frame members 282, 283 are L-shaped each with an upper extending portions 282a, 283a for connecting with the winch unit 280 and a lower extending portions 282b, 283b for connecting with the right and left ladder rail receivers 284, 286. The winch unit 280 has a mounting bracket 292. The mounting bracket 292 has two spaced apart mounting bracket holes. Each of the front and back frame members comprise two spaced apart mounting holes 294, 296, 298, 300. Two pins 302, 304 are attached to the winch unit 280 by corresponding chains 306, 308. The pins are shown withdrawn from the holes 294, 296, 298, 300 and resting on the lower extending portion 282b in FIG. 13.

To secure the winch unit to the front and back frame members 282, 283, pins 302, 304 are inserted in the corresponding holes 294, 296 of member 282 and through the corresponding holes in the winch unit mounting bracket 292, and through the corresponding holes 298, 300 in member 283. A locking clip or pin (not shown) may be placed through a hole (not shown) in an end of each pin 302, 304 to prevent the pin from inadvertent withdraw from the holes.

In some embodiments, the right and left ladder rail receivers 284, 286 are clamps or vices that do not entirely enclose the ladder rail but secure thereto by a gripping force. In some embodiments, the right and left ladder rail receivers 284, 286 comprise a clamp to grip the ladder rail.

In some embodiments, the front and back frame members 282, 283 are joined together with one or more cross members (not shown). In some embodiments, front and back frame members 282, 283 maybe one unit. The winch unit 280 can be removed from the frame members 282, 283, by removing the pins and withdrawing the winch unit from the frame members 282, 283. In some embodiments, the winch unit 280 may be one that is relatively light for ease of transportation and that has at least a lifting capacity of 400 pounds.

The right and left ladder rail receivers 284, 286 each have a lower openings 310, 312 for receiving the corresponding top portion of the right rail 60 and left rail 62 of the ladder. The lower openings 310, 312 of the right and left ladder rail receivers 284, 286 open to a hollow interior bounded by the walls of the right and left ladder rail receivers 284, 286. The hollow interior may be sized and configured to receive the corresponding right side rail 60 and left side rail 62 of a conventional ladder or may be configured to receive such rails of various types of ladders. The tops of the rails 60, 62 will reset against end walls 314, 316 of the corresponding right and left ladder rail receivers 284, 286 to support the hoist assembly.

The right lighting unit provides lighting in an upper right lighting area 318 and a lower right lighting area 320. The left lighting unit 290 provides lighting in an upper left lighting area 322 and a lower left lighting area 324. The upper lighting areas 318, 322 are for the rescue team working on the upper floor 56. The lower lighting areas 320, 324 are for the rescue team working on the lower level 54.

The right and left lighting units 288, 290 are identical so only unit 288 will be described. The lighting unit 228 has an on/off button 326, a mode button 328, a green/white button 330, a low battery light 332, a first bank of LEDs (light emitting diodes) 334, a second bank of LEDs 340, a light controller 342, and a battery 346. Each bank of LEDs comprises one or more individual LEDs 335, 341. The controller is in signal communication with the on/off button 326, the mode button 328, the green/white button 330, the low battery light 332, the first bank of LEDs 334, the second bank of LEDs 340, and the battery 346. The on/off button 326 is connected to the controller and when the on/off button is pressed the controller will direct power from the battery to one or both of the banks of LEDs 334, 340 if the LEDs were off immediately prior to the button being pushed. If the LEDs are on immediately prior to the on/off button being pushed, then the controller will direct that power be stopped to the LEDs to turn them off when the button is pushed.

The light controller 342 may be an application-specific integrated circuit (ASIC) having one or more processors and memory blocks including ROM, RAM, EEPROM, Flash, or the like; a programmed computer having a microprocessor, microcontroller, or other processor, a memory, and an input/output device; a programmable integrated electronic circuit; a programmable logic controller or device; or the like. Any device or combination of devices on which a finite state machine capable of implementing the procedures described herein can be used as the light controller 342.

When the power is on, the mode button allows the user to switch, via instructions from the controller, between lighting provided at the first bank of LEDs 334 only, at the second bank of LEDs 340 only, or at both the first and second banks of LEDs. In some embodiments, each bank of LEDs includes at least one sub-bank of white LEDs that provide white light and at least one sub-bank of green LEDs that provide green light. When the power is on, the pressing the green/white button causes the controller to switch between powering the green sub bank and the white sub bank in either or both of the LED banks 334, 340 that are powered according to the currently selected mode. If the white sub-bank is illuminated and the green/white button is pushed, the controller will power off the white sub-bank and power-on the green sub-bank. Green light may provide better visibility than white light in certain situations, such as in a smoke filled environment.

The lighting units can provide light in the lower level through the lower right lighting area 320 and the lower left lighting area 324. In some embodiments, the lighting spans from the right boundary of the lower right lighting area 320 across the ladder to the left boundary of the lower left lighting area 324. In some embodiments, the lighting spans from the right boundary of the upper right lighting area 318 across the ladder to the left boundary of the upper left lighting area 322. In some embodiments, the lighting areas 318, 322, 320, 324 may be wider or narrower than shown in FIGS. 1-3. The lighting units provide light to the lighting areas to assist the rescue workers in the corresponding areas.

The controller has a function to measure the power level of the battery and indicate when the battery 346 power level is below a pre-defined threshold, such as 10, 7, 5, or 3 percent. If the power is measured to be below the pre-defined threshold then the controller will cause power to be directed to the low battery light 332 to cause it to illuminate to indicate a low power condition to the user.

The first bank of LEDs 334 is shown placed at a front side 336 of the lighting unit 288. In other embodiments, the first bank of LEDs 334 is located on the right side 289 of the lighting unit 288 to project light to the right lighting upper area 318. In other embodiments, the first bank of LEDs 334 is shown placed at a front side 336 and angled to provide light to the right lighting upper area 318 as shown in FIG. 1.

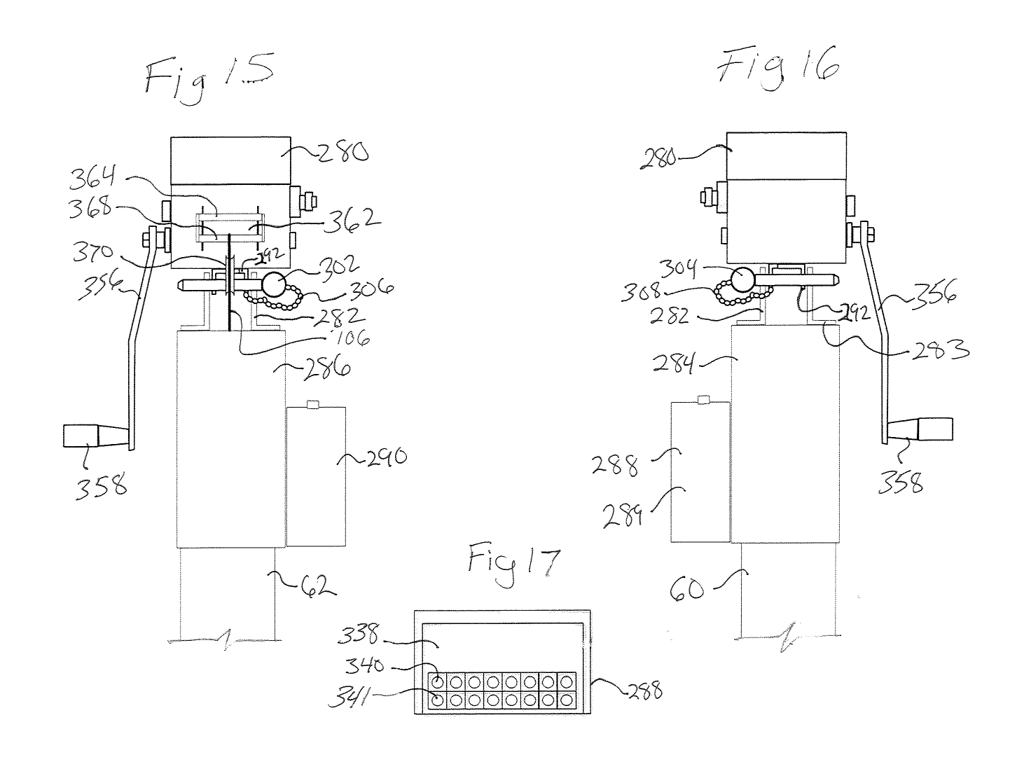

The second bank of LEDs 340 is located on a bottom side 338 of the lighting unit 288 as shown in FIG. 17. The second bank of LEDs direct light to illuminate the lower right lighting area 320 as shown in FIG. 1. In one embodiment, each LED of the LED bank provides between 60 and 120 lumens of light intensity. LEDs with other intensities can be used. The LEDs banks can comprise additional LEDs beyond what is shown in FIGS. 13 and 17 to provide more or less lighting.

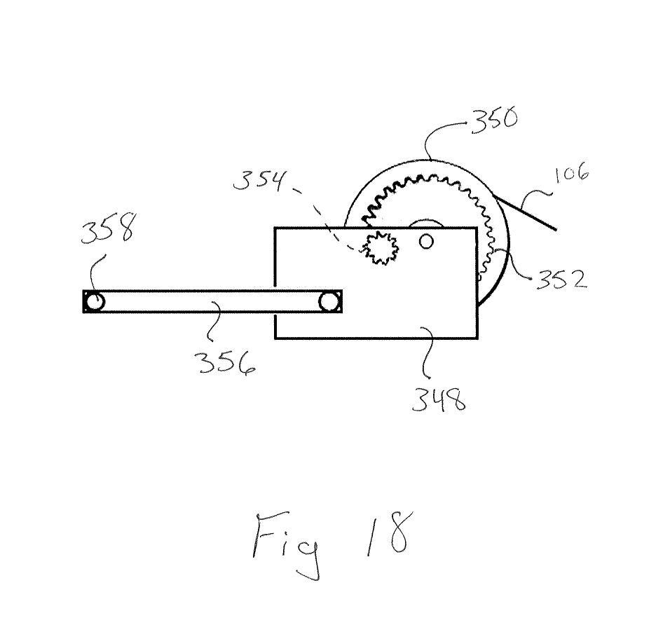

The winch unit 280 comprises a gearbox 348, a spool 350, a ring gear 352, a sprocket 354, reduction gears (not shown), a crank 356, and a handle 358 shown in FIG. 18. The spool contains cable 106 that is secured at one end to the spool. The cable is at least partially wound around the spool and extends from the spool. The spool has the ring gear 352 that meshes with the sprocket 354. The sprocket is operatively connected to the crank 356 through the reduction gears. In some embodiments, the crank handle is removed and an electric motor drives the reduction gears powered from a battery power source through a power switch operable by the user. In some embodiments, the gearing provides a 4.1:1 turn ratio between the crank arm and the spool. The handle 358 is located on the back of the winch unit so that the rescuer can stand behind the ladder turning the crank as the hoisting operation occurs. In some embodiments, the winch unit is a Miller ManHandler Hoist/Winch 8440SS by Honeywell International Inc., which meets the ANSI (American Society of Safety Engineers) standard Z117.1.

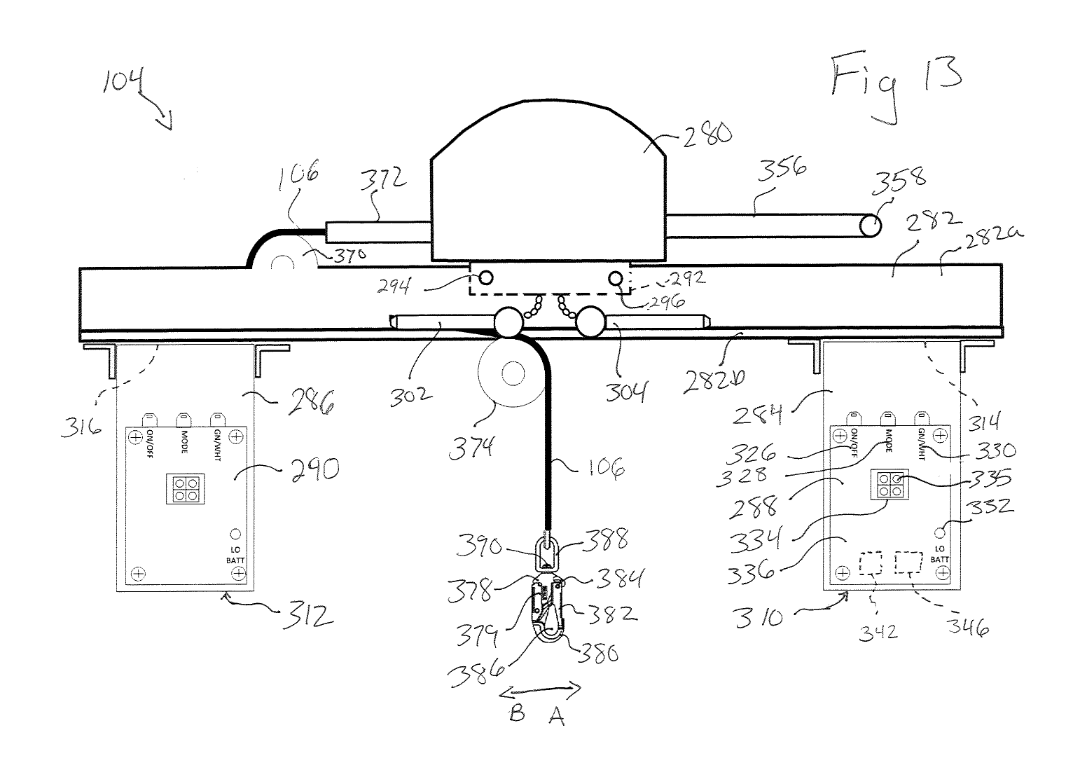

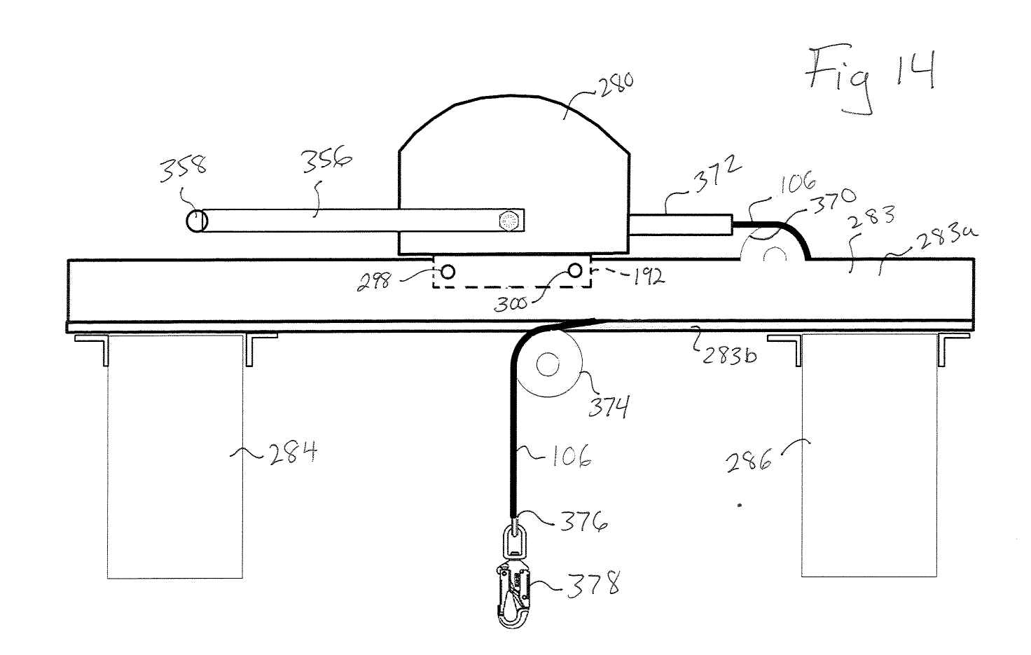

The cable 106 extends out a side cable opening 362 in the housing of the winch unit 280 as shown in FIG. 15. The side cable opening 263 may have upper and lower rollers 364, 368 to facilitate the smooth movement of the cable in and out of the cable opening 362. In addition to the rollers 364, 368, an extended tube may enclose the cables travel toward a first pulley 370 as shown in FIGS. 13 and 14. The cable extends down and around the first pulley 370 between the front and back frame members 282, 283 to a center second pulley 374. The cable extends around the left side of the second pulley 374 to a central position between the right and left ladder rail receivers 284, 286. The first and second pulleys 370, 374 are supported by a rotatable attachment to the front and/or the back frame members 282, 283 which allows the pulley to rotate about a pivot point/shaft.

The far end 376 of the cable 106 is connected to a hook 378. The hook can be any hook known in the art capable of holding the required maximum lift weight. The hook may have a springed closing mechanism, such as that shown in FIG. 13. The hook 378 has a main body 379 with a top curve 380. The top curve is configured to meet the closing arm 382 when the closing arm is in the closed position as is shown in FIG. 13. The main body 379 comprises a spring (not shown) that biases the closing arm 382 away from the main body and to contact with the end of the top curve 380 in the direction A of FIG. 13.

The closing arm 382 pivots about the pivot shaft 384. The end of the top curve 380 is positioned to prevent the closing arm from traveling past the end of the top curve in the direction A. The hook is opened by pushing the closing arm in the direction B toward the main body to provide access to the receiving area 386. Once an item, such as eyelet 140, 246 is in the receiving area 386, the spring forces the closing arm 382 to the close position. Therefore, the eyelet is enclosed in the interior area of the hook and cannot be removed, until the closing arm is forced back in the direction B sufficient to allow the eyelet to escape the receiving area 386. The hook can be 360 degree rotatably mounted via a pivot connection 390 to a D-ring 388 connected to the cable 106 for maximum maneuverability of the hook. The hook can be quickly-released by pushing the closing arm in the direction B and withdrawing the eyelet 140, 246 from the receiving area 386.

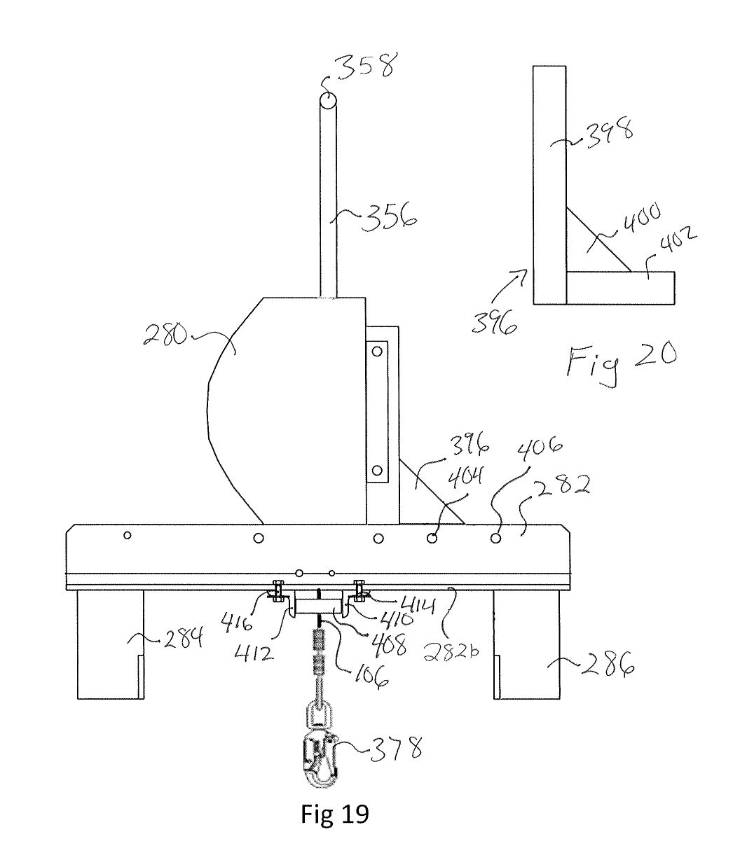

FIGS. 19 and 20 show the winch unit mounted to the front and back frame members 282, 283 in an orientation that is rotated 90 degrees counterclockwise from the orientation shown in FIG. 13. In this orientation of FIG. 19, the opening 362 of the winch housing through which the cable extends is directed downward between the front and back frame members 282, 283. Therefore the need for one or both of the pulleys 370, 374 is eliminated. The load that the system can bear can be increased to the load bearing rating of the winch, without the need to ensure that the pulleys and corresponding mounting for the pulley is rated to bear the increased weight.

An L-bracket 396 is used to connect the winch mounting bracket 292 to the front and back frame members 282, 283. The L-bracket 396 has an upper bar 398 and the lower bar 402 connected at a right angle. A connecting triangle brace 400 is located at the intersection of bar 398 and 402 to provide additional strength. Each of the bars 398 and 402 has two spaced apart holes (not shown), The holes in bar 398 are for mounting pins 302, 304 or other fasteners to connect the winch mounting bracket 292 to the bar 398 of the L-bracket. The two holes in bar 402 are for aligning with L-bracket holes 404, 406 of the front and back frame members 282, 283. Fasteners (not shown) extend through the aligned holes to join the L-bracket to the front and back frame members 282, 283.

A front roller 408 and a back roller (not shown) are rotatably attached to the corresponding bottom of the lower extending portions 282b, 283b, in a cable exit area. The back roller is identical the front roller 408 and identically mounted to the lower extending portion 283b, so only front roller 408 will be described. The roller 408 provides a rolling surface for the cable to engage to guide the cable and prevent frictional contact with the front frame member 282. The roller 408 is rotatably connected to the lower extending portion 282b by to L-brackets 410, 412. The L-brackets are connected the lower extending portion 282b by fasteners 414, 416, such as bolts joined with nuts.

In operation, the ladder 50 is placed in the desired location for the rescue. The hoist unit is then placed on the top of the ladder. In some usages, the hoist unit is already attached to the ladder. Then one or more rescue workers will climb down the ladder to the lower level to secure the victim to the sled. The hook may be at a raised location close to the front and back frame members 282, 283 as shown in FIG. 13. A user will rotate the crank in a unwind rotation direction, such as counterclockwise. The cable will unwind from the spool 350 and cause the hook to be lowered.

The sled 102, 222 may be lowered attached to the hook 360 or may be carried down the ladder by one of the rescue workers or otherwise transported to the location of the victim. The sled is placed against the ladder with the sled rollers located at or near the bottom of each of the ladder side rails 60, 62. Then the victim is moved to the sled and the harness system is deployed to secure the victim to the sled, such as shown in FIGS. 10-12. In one application, it took 20 to 30 seconds to secure the victim to the sled with the 6-point harness system 161.

If the hook is not already attached to the sled, the hook is secured to the eyelet 140, 246. One or more rescuers operates the handle 258 of the crank 256 to cause the crank to rotate in the wind direction, such as clockwise, to cause the cable and the attached sled and victim to be raised as the cable is wound around the spool. The rollers 208 and 210 roll along the rails 60,62 of the ladder as the sled is lifted with the winch. Due to the central position of the winch and the load of the victim on the sled, the upper end of the sled opposite the rollers will typically be raised from contact with the rails 60,62 during the hoisting operation. This is in part due to the victim's tendency slump forward and as a consequence of the weight of the victim being towards the bottom of the sled in the orientation of the lift. In is also possible that the upper end of the sled will slide along the rails 60, 62 during the hosting operation.

The one or more rescue workers can move the sled away from the ladder to landing areas 392, 394 on the upper floor 56 adjacent the ladder when the sled and/or the victim reach the top of the ladder, or are above the upper floor 56, or are close to the top of the ladder, or at least when the victim is close enough for rescuers on the upper floor 56 to grab the sled and bring the sled one of the landing areas. In the case of the second embodiment sled 222, the rescues can grab one or more of the handles 270, 272, 273 to lift the sled and/or move the sled to a landing area.

Once rescuer(s) on the upper level have a hold of the sled, a rescuer might rotate the winch unit in the unwind direction to allow slack on the cable so that the attached sled can be moved to one of the adjacent landing area(s). If slack is provided to the cable, at that point, the sled and or the victim may be at least partially supported by one or more rescuers or by a surface of the upper floor. In another method, rather than or in addition to providing slack in the cable, the hook can be disconnected from the sled before, during, or after the move of the sled to one of the landing areas, as long as the sled or the victim or both are supported by the rescuers or the upper floor 56 or both.

Landing areas 392, 394 shown in FIG. 3 are only example areas, any area adjacent the ladder on the upper floor 56 were the sled can be received can be a landing area. Once the sled and the victim are safely in the landing area, the harness system can be released and the victim can be removed from the sled.

In some environments or usages, the sled and the victim may remain on the ladder at or adjacent to top of the ladder, as shown in FIG. 3, and the ladder may be withdrawn from the opening 58 on to the upper level without removing the sled or victim. The ladder may have to be withdrawn to the point where it can lay flat on the upper level 65 or otherwise be in a stable position before the victim or the sled are removed from the sled or the ladder, respectively.

During the winching operation when the victim is being lifted by the winch, one or more rescuers may need to hold the bottom of the ladder to prevent the ladder from becoming unbalanced as the sled reaches the top. In other methods, an object may be placed against the bottom of the ladder to secure the bottom of the ladder against movement as the sled and victim are hoisted.

In some methods, only two rescuers are needed to operate the extraction system. One person is at the bottom securing the victim to the sled and the other person is at the top operating the winch unit to hoist the victim and move the victim to one of the landing areas.

During testing of the extraction system in some environments, the rescue team members can hoist a victim up a 12 foot ladder in between 23 and 35 seconds. Further, the extraction system reduced the time required to perform the rescue effort by an average factor of 12 as compared to the manual rope method. Therefore, a rescue effort with the extraction system can extract a victim 12 times faster that the traditional rope rescue team.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. An extraction system, comprising:
a hoist assembly comprising two spaced apart rail receiving members configured to connect with side rails of an end of a ladder, and a winch, the winch comprising a cable;
a sled comprising a frame, a platform connected to the frame, and a harness for connecting a rider to the platform;
the cable is releasably connected to the sled;
the winch operable to move the sled via the cable along the ladder from a lowered position to a raised position.

2. The system of claim 1, wherein the sled comprises rollers configured to roll along side rails of the ladder when the sled is moved along the ladder by the winch.

3. The system of claim 1, wherein the sled comprises a plurality of attachment locations for anchoring a plurality of straps of the harness.

4. The system of claim 3, wherein the harness comprises at least one buckle for connecting at least two of the plurality of straps together about a rider.

5. The system of claim 1, wherein the harness is a six-point harness system configured to restrain a rider's chest, torso, and legs.

6. The system of claim 1, wherein the cable is releasably connected to the sled by a quick release mechanism.

7. The system of claim 1, wherein the sled has one or more handles.

8. The system of claim 1, wherein the sled comprises a hook receiver and the cable comprises a closable hook configured to connect with the hook receiver.

9. The system of claim 1, wherein the hoist assembly comprises a crossbar connecting the rail receiving members, the winch is connected to the crossbar on a side of the cross bar opposite of the rail receiving members.

10. The system of claim 1, wherein the rail receiving members each comprise a housing enclosed on three sides with a lower opening for receiving the corresponding side rail of the ladder.

11. The system of claim 1, wherein the hoist assembly comprises one or more pulleys to route the cable to a location between the rail receiving members.

12. The system of claim 1, wherein the winch comprises a hand crank rotatable to move the cable in at least one direction.

13. The system of claim 1, wherein the winch is driven by an electric motor.

14. The system of claim 1, therein the hoist assembly comprises a one or more lights for illuminating a work area.

15. The system of claim 1, wherein the hoist assembly comprises a one or more lighting control units and one or more lights, the lighting control units control the operation of the one or more lights.

16. The system of claim 1, comprising one or more light emitting diodes, and wherein the one or more lighting control units comprises a lighting color selector for selecting the color of light to be illuminated from the one or more light emitting diodes.

17. An extraction apparatus, comprising:
a hoist assembly comprising two spaced apart rail connectors configured to connect with side rails of an upper end of a ladder, and a winch, the winch comprising a cable;
a sled comprising a frame, a platform connected to the frame, and a harness connecting a rider to the platform;
the cable is releasably connected to the sled;
the winch operable to move the sled along the ladder with the cable from a lowered position to a raised position.

18. The apparatus of claim 17, wherein the sled comprises rollers configured to roll along side rails of the ladder when the sled is moved along the ladder by the winch.

19. The system of claim 1, therein the hoist assembly comprises a one or more lights for illuminating a work area.

20. An method of extracting a person from a lower location, comprising the steps of:
positioning a ladder on the lower level where the ladder extends to an upper level;
attaching two spaced apart rail connectors of a hoist assembly to the upper end of side rails of the ladder, the hoist assembly comprising a winch;
securing the person located at the lower location to a sled with a harness;
drawing the sled up the ladder toward the upper level with the winch, the winch connected to the sled by a cable.
